(19) United States
(12) Patent Application Publication
(10) Pub. No.: US 2020/0037165 A1
(43) Pub. Date: Jan. 30, 2020

(54) SECURITY PROTECTION FOR USER PLANE TRAFFIC

(71) Applicant: Lenovo (Singapore) Pte. Ltd., New Tech Park (SG)

(72) Inventors: Andreas Kunz, Ladenburg (DE); Prateek Basu Mallick, Dreieich (DE); Genadi Velev, Darmstadt (DE); Joachim Loehr, Wiesbaden (DE); Ravi Kuchibhotla, Clarendon Hills, IL (US)

(21) Appl. No.: 16/526,791

(22) Filed: Jul. 30, 2019

Related U.S. Application Data
(60) Provisional application No. 62/712,148, filed on Jul. 30, 2018.

(51) Int. Cl. H04W 12/10; H04W 12/08; H04W 12/00; H04W 8/08; H04W 8/24; H04W 60/00; H04W 80/10

(52) U.S. Cl. CPC H04W 12/10; H04W 12/08; H04W 12/0013; H04W 80/10; H04W 8/24; H04W 60/00; H04W 8/08

(57) ABSTRACT

Apparatuses, methods, and systems are disclosed for selective security protection of user plane traffic. One apparatus includes a transceiver that sends a UE security capability to a mobile communication network and receives an indication of data protection policy. The apparatus includes a processor that applies a security protection to a subset of user plane traffic with the mobile communication network according to the data protection policy. In such embodiments, a portion of the user plane traffic is communicated without the security protection.

### CROSS-REFERENCE TO RELATED APPLICATIONS

This application claims priority to U.S. Provisional Patent Application No. 62/712,148 entitled “EFFICIENT SECURITY PROTECTION IN WIRELESS SYSTEMS” and filed on Jul. 30, 2018 for Andreas Kunz, Prateek Basu Mallick, Genadi Velev, Joachim Loehr, and Ravi Kuchibhotla, which is incorporated herein by reference.

### FIELD

The subject matter disclosed herein relates generally to wireless communications and more particularly relates to security protection of user plane traffic.

### BACKGROUND

The following abbreviations and acronyms are herewith defined, at least some of which are referred to within the following description.

Third Generation Partnership Project (“3GPP”), Fifth-Generation Core (“5GC”), Fifth-Generation QoS Indicator (“5QI”), Access and Mobility Management Function (“AMF”), Access Network Performance (“ANP”), Access Point Name (“APN”), Access Stratum (“AS”), Access Traffic Steering, Switching and Splitting (“ATSSS”), Allocation/Retention Policy (“ARP”), Application Programing Interface (“API”), Carrier Aggregation (“CA”), Clear Channel Assessment (“CCA”), Control Channel Element (“CCE”), Channel State Information (“CSI”), Common Search Space (“CS S”), Data Network Name (“DNN”), Data Radio Bearer (“DRB”), Differentiated Services Code Point (“DSCP”), Downlink Control Information (“DCI”), Downlink (“DL”), Enhanced Clear Channel Assessment (“eCCA”), Enhanced Mobile Broadband (“eMBB”), Encapsulating Security Payload (“ESP”), Evolved Node-B (“eNB”), Evolved Packet Core (“EPC”), Evolved UMTS Terrestrial Radio Access Network (“E-UTRAN”), European Telecommunications Standards Institute (“ETSI”), Echo Acknowledgement Indicator (“EAI”), Request Indicator (“ERP”, ERI-d refers to an ERI associated with a dummy payload and ERI-v refers to an ERI associated with a valid payload), Fixed Access Gateway Function (“FAGF”), Fixed Network Residential Gateway (“FN-RG”), Frame Based Equipment (“FBE”), Frequency Division Duplex (“FDD”), Frequency Division Multiple Access (“FDMA”), Generic Routing Encapsulation (“GRE”), Globally Unique Temporary UE Identity (“GUTI”), General Packet Radio Service (“GPRS”), GPRS Tunneling Protocol (“GTP”, GTP-C refers to control signal tunneling while GTP-U refers to user data tunneling), Hybrid Automatic Repeat Request (“HARQ”), Home Subscriber Server (“HSS”), Internet-of-Things (“IoT”), IP Multimedia Subsystem (“IMS,” aka “IP Multimedia Core Network Subsystem”), Internet Protocol (“IP”), Key Performance Indicators (“KPI”), Licensed Assisted Access (“LAA”), Load Based Equipment (“LBE”), Listen-Before-Talk (“LBT”), Long Term Evolution (“LTE”), LTE Advanced (“LTE-A”), Medium Access Control (“MAC”), Multiple Access (“MA”), Modulation Coding Scheme (“MCS”), Machine Type Communication (“MTC”), Massive MTC (“mMTC”), Mobility Management (“MM”), Mobility Management Entity (“MME”), Multiple Input Multiple Output (“MIMO”), Multipath TCP (“MPTCP”), Multi User Shared Access (“MUSA”), Non-Access Stratum (“NAS”), Narrowband (“NB”), Network Function (“NF”), Network Access Identifier (“NAI”), Next Generation (e.g., 5G) Node-B (“gNB”), Next Generation Radio Access Network (“NG-RAN”), New Radio (“NR”), Policy Control & Charging (“PCC”), Policy Control Function (“PCF”), Policy Control and Charging Rules Function (“PCRF”), Packet Data Network (“PDN”), Packet Data Unit (“PDU”), PDN Gateway (“PGW”), Public Land Mobile Network (“PLMN”), Quality of Service (“QoS”), QoS Class Identifier (“QCI”), Quadrature Phase Shift Keying (“QPSK”), Registration Area (“RA”), Radio Access Network (“RAN”), Radio Access Technology (“RAT”), Radio Resource Control (“RRC”), Receive (“RX”), Reflective QoS Indicator (“RQI”), Single Network Slice Selection Assistance Information (“S-NSSAI”), Scheduling Request (“SR”), Secure User Plane Location (“SUPL”), Serving Gateway (“SGW”), Session Management Function (“SMF”), Stream Control Transmission Protocol (“SCTP”), System Information Block (“SIB”), Tracking Area (“TA”), Transport Block (“TB”), Transport Block Size (“TBS”), Transmission Control Protocol (“TCP”), Time-Division Duplex (“TDD”), Time Division Multiplex (“TDM”), Transmission and Reception Point (“TRP”), Transmit (“TX”), Trusted WLAN Interworking Function (“TWIF”), Uplink Control Information (“UCI”), Unified Data Management (“UDM”), User Entity/Equipment (Mobile Terminal) (“UE”), Uplink (“UL”), User Plane (“UP”), Universal Mobile Telecommunications System (“UMTS”), Ultra-reliability and Low-latency Communications (“URLLC”), User Datagram Protocol (“UDP”), UE Route Selection Policy (“URSP”), Wireless Local Area Network (“WLAN”), Wireless Local Area Network Selection Policy (“WLANSP”), and Worldwide Interoperability for Microwave Access (“WiMAX”).

A man-in-the-middle attack occurs when an attacker secretly relays (and possibly alters) the communication between two parties with their directly communicating with each other. In LTE, a mobile (e.g., UE) may be susceptible to a man-in-the-middle attack (e.g., a Layer-2 attack) where an attacker redirects the mobile to fraudulent web site using a false eNB. In such an attack, the false eNB detects an encrypted DNS request from the mobile and changes the destination IP address to a public IP address of the server controlled by the fraudster, which redirects the mobile to the fraudulent website. The LTE mobile is susceptible to such attacks because the LTE standard does not mandate the integrity protection of the user plane data. Thus, the LTE mobile is susceptible to the stack even when the user plane traffic is encrypted and not just when “no encryption” is used.

Moreover, early 5G chipsets may be unable to provide integrity protection at the fully possible data throughput, such that operators may be forced to turn off integrity protection. User plane integrity protection on 3GPP level is not specified for LTE/pre-Release 15 networks and user plane integrity protection cannot be included in the specifications because there are existing UEs rolled-out. Additionally, for 5G the computation power in the UEs may not be sufficient for implementing integrity protection at high data rates because the integrity protection is performed on PDCP level, e.g., in the modem processor of the chipset, which may not be powerful enough for the complex computations at high data rates. Although HTTPS and/or VPN tunneling may be used to mitigate the risk of attack, such solutions act on layers above the 3GPP transport layer that are outside the scope of 3GPP. Thus, the 3GPP user plane is still susceptible to attack in many implementations.

Note that HTTPS (especially HTTP Strict Transport Security (HSTS)) may help to prevent the redirection to a malicious website and a VPN tunnel with integrity protection and end point authentication may also help to prevent the man-in-the-middle attack. The VPN tunnel acts similar to HTTPS as additional security layer.

In a second type of Layer-2 attack, the attacker analyzes mobile data usage without decrypting the data, but with guesswork. For example, the attacker may guess at the website visited from the timing and size of the data packets.

### BRIEF SUMMARY

Methods for selective security protection of user plane traffic are disclosed. Apparatuses and systems also perform the functions of the methods.

A first method for selective security protection of user plane traffic includes sending a UE security capability to a mobile communication network and receiving an indication of data protection policy. The first method includes applying a security protection to a subset of user plane traffic with the mobile communication network according to the data protection policy, wherein a portion of the user plane traffic is communicated without the security protection.

A second method for selective security protection of user plane traffic includes receiving a security policy from a network function, the security policy indicating a user plane data protection policy for a UE and sending an indication of the data protection policy to the UE. The second method includes applying security protection to a subset user plane traffic with the UE according to the data protection policy, wherein a portion of the user plane traffic is communicated without the security protection.

A third method for selective security protection of user plane traffic includes receiving a UE security capability for security protection from a UE and via a RAN node and deriving a data protection policy based on the UE security capability. The third method includes sending the data protection policy to the RAN node, wherein the RAN node and UE are to apply integrity protection to user plane traffic according to the data protection policy, wherein a portion of the user plane traffic is to be communicated without the security protection.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for selective security protection of user plane traffic;

FIG. 2A is a block diagram illustrating a first network procedure to implement efficient security protection;

FIG. 2B is a continuation of the procedure of FIG. 2A;

FIG. 3A is a block diagram illustrating a second network procedure to implement efficient security protection;

FIG. 3B is a continuation of the procedure of FIG. 3A;

FIG. 4 is a schematic block diagram illustrating one embodiment of a user equipment apparatus for selective security protection of user plane traffic;

FIG. 5 is a schematic block diagram illustrating one embodiment of a base station apparatus for selective security protection of user plane traffic;

FIG. 6 is a schematic block diagram illustrating one embodiment of a network equipment apparatus for selective security protection of user plane traffic;

FIG. 7 is a flow chart diagram illustrating a first embodiment of method for selective security protection of user plane traffic;

FIG. 8 is a flow chart diagram illustrating a second embodiment of a method for selective security protection of user plane traffic; and

FIG. 9 is a flow chart diagram illustrating a third embodiment of a method for selective security protection of user plane traffic.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects.

For example, the disclosed embodiments may be implemented as a hardware circuit comprising custom very-large-scale integration (“VLSI”) circuits or gate arrays, off-the-shelf semiconductors such as logic chips, transistors, or other discrete components. The disclosed embodiments may also be implemented in programmable hardware devices such as field programmable gate arrays, programmable array logic, programmable logic devices, or the like. As another example, the disclosed embodiments may include one or more physical or logical blocks of executable code which may, for instance, be organized as an object, procedure, or function.

Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store, a program for use by or in connection with an instruction execution system, apparatus, or device.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams.

The code may also be loaded onto a computer, other programmable data processing apparatus, or other devices to cause a series of operational steps to be performed on the computer, other programmable apparatus, or other devices to produce a computer implemented process such that the code which execute on the computer or other programmable apparatus provide processes for implementing the functions/acts specified in the schematic flowchart diagrams and/or schematic block diagram.

The schematic flowchart diagrams and/or schematic block diagrams in the Figures illustrate the architecture, functionality, and operation of possible implementations of apparatuses, systems, methods, and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

The description of elements in each figure may refer to elements of proceeding figures. Like numbers refer to like elements in all figures, including alternate embodiments of like elements.

Methods, apparatuses, and systems are disclosed for selective security protection of user plane traffic. Generally, the present disclosure describes systems, methods, and apparatus that support efficient security protection in wireless systems. In various embodiments, efficient security protection provided using an improved integrity protection on the user plane. As described herein, integrity protection may be selectively applied to the user plane. The present disclosure describes various options for selectively applying integrity protection, e.g., on select packets, or for selected time direction, or for a selected traffic direction (e.g., uplink or downlink), or combinations thereof.

Note that the present disclosure uses terminology to describe various messages and procedures as outlined in 3GPP LTE and NR specifications available at the time of filing. While the procedures and Figures use 5G 3GPP terminology (e.g., depicting 5GS network functions and signaling), principles and concepts described herein may also be applied to other wireless communication systems (e.g., LTE deployments).

One solution for efficient security protection and wireless systems includes providing backwards compatibility with minimum change to the UE and the network by providing realistic performance for higher data rates, in order to prevent the situation where integrity protection is not used (e.g., turned off) by the mobile operator. As described above, chipset limitations may prevent conventional integrity protection to be applied to all data packets at high data rates.

To compensate for chipset limitations, integrity protection may be performed for selected packets according to a pattern, e.g., every second packet of data flow in uplink and downlink, or for a specific direction (e.g., one of DL and UL). This solution allows asymmetric integrity protection in order to enhance the performance in the UE by easing the processing and computation requirements only for one direction. In various embodiments, integrity protection may be performed only in one transmission direction (e.g., UL or DL). Additionally, the security policy may be enhanced to allow selected packets to be encrypted. To implement selective security protection, a UE may communicate its user plane integrity protection (“UP IP”) capability to the network, discussed in detail below.

As used herein, “symmetric integrity protection” refers to the application of integrity protection to all packets of the user plane traffic in both the uplink and downlink directions. As used herein, “asymmetric integrity protection” refers to the application of integrity protection to all packets of the user plane traffic in either the uplink direction or the downlink direction. As used herein, “selective integrity protection” refers to the application of integrity protection to only a subset of the packets of user plane traffic. With selective integrity protection, the integrity protection may be selectively applied in the uplink direction only, the downlink direction only, or in both uplink and downlink directions. Note that “asymmetric integrity protection” may be considered a type of “selective integrity protection” as packets in only one direction are given integrity protection. In other examples of “selective integrity protection,” the integrity protection may be applied according to a packet pattern in the uplink and/or downlink directions.

In various embodiments, additional enhancements may be provided to the data protection policy for selective security protection of user plane traffic. In some embodiments, only certain (e.g., selected) packets are given integrity protection. When only selected packets are integrity protected, such packets may be the first ‘x’ number of packets (e.g., the first 100 packets) of the PDU session traffic when the UE transfers from IDLE to CONNECTED state are given integrity protection. Here, a “packet” may refer to a PDCP service data unit (“SDU”). In such an embodiment, when the user plane resources are activated (e.g., DRB or N3 tunnel) for a PDU session to which UP IP is applied, then the integrity protection is applied to the certain number (e.g., ‘x’ number) of the first packets.

When only selected packets are integrity protected, such packets may be the first T ms (or other unit of time) when user plane resources are activated (e.g., DRB or N3 tunnel) for a PDU session requiring integrity protection. For example, integrity protection may be required for the first 100 ms (or first 1000 ms) after an application starts. When only selected packets are integrity protected, such packets may be selected as any packet with the size less than or equal to ‘y’ bytes.

In certain embodiments, when only selected packets are integrity protected, such packets may be according to a pattern. In one embodiment, the pattern applies integrity protection to ‘z’ packets periodically. For example, integrity protection may be applied to 100 PDCP SDUs every 10 ms. In another embodiment, the integrity protection is cyclic such that the pattern applies integrity protection to every ‘w’ number of packets. For example, integrity protection may apply to every 20^{th} packet. Moreover, combinations of the above may be applied when selecting the packets to be given integrity protection (e.g., a combination of selecting the first ‘x’ packets (or ‘t’ ms worth of packet) and thereafter selecting packets according to a pattern).

Note that the selection criteria may be specified, configurable by network in the security policy, or configured in the UE itself based on the type of triggering application by higher layers in the UE. In addition, higher layers may indicate to PDCP which SDUs need to be ciphered/encrypted/protected (inter-process communication), for example SDU(s) carrying DNS query. In certain embodiments, higher layers may vary the size and position of the DNS query itself by padding the packet size to a size not falling into the filter criteria of the attacker on DNS queries. Such size may be determined empirically and/or may be configured at the network.

In some embodiments, an indication as to which PDCP PDUs carry a MAC-I may be included in the PDCP header. For example, a one-bit Boolean indicator may be included in the header. Here, a value of “true” indicates that the MAC-I is included while the value of “faults” indicates that the MAC-I is not included. Accordingly, the receiver will parse the PDCP PDU based on this indication. All the PDCP PDUs without MAC-I may have the MAC-I padded with zeros.

In a further enhancement, the header part containing the MAC-I and the indicator (e.g., one-bit Boolean flag) may be ciphered/encrypted, but with other header parts (e.g., PDCP SN) being transmitted without being ciphered/encrypted.

A UE implementing the efficient security protections described herein, may thus send UE security capabilities for selective (e.g., asymmetric and/or pattern based) integrity protection. Additionally, the UE may perform key derivations as described above. The UE may use the no algorithm in one direction and integrity protection/check in the other direction for asymmetric integrity protection of the user plane. In various embodiments, the UE perform selective integrity protection using a provisioned security policy. For example, the policy may cause the selection based on packet size, initial number of packets, cyclic number of packets, or combinations thereof.

An SMF implementing the efficient security protections described herein may include the ability to receive and process UE security capabilities and a security policy for selective integrity protection for a PDU session. The SMF may perform determination of the best selective integrity protection method based on the UE capabilities to achieve the best level of integrity protection (especially with consideration of higher data rates). For example, the SMF may choose at least one of symmetric, asymmetric, and selective integrity protection (with selection based on packet size, initial number of packets, cyclic number of packets, or combinations thereof) with a corresponding policy. Moreover, the SMF sends the policy of selective integrity protection to the RAN node.

A RAN node (e.g., a gNB) implementing the efficient security protections described herein may include the ability to receive (e.g., from an SMF) and process policies for selective integrity protection. Moreover, the ran node may configure the UE (e.g., during RRC connection configuration procedure) to apply selective integrity protection in the user plane for the DRBs of a particular PDU session.

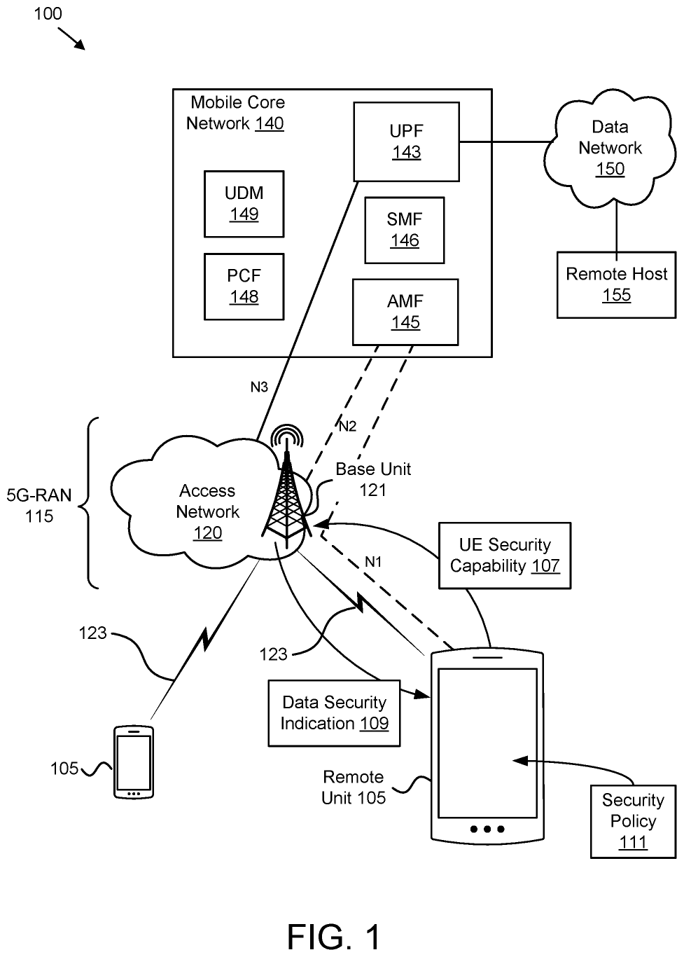

FIG. 1 depicts a wireless communication system 100 for selective security protection of user plane traffic, according to embodiments of the disclosure. In one embodiment, the wireless communication system 100 includes at least one remote unit 105, a 5G-RAN 115, and a mobile core network 140. The 5G-RAN 115 and the mobile core network form a mobile communication network. The 5G-RAN 115 may be composed of an access network 120 containing at least one base unit 121. The 5G-RAN 115 may include a 3GPP access network and/or a non-3GPP access network (e.g., Wi-Fi).

The remote units 105 communicate with the 5G-RAN 115 using a wireless communication links 123. For example, a remote unit 105 may communicate with a 3GPP access network using 3GPP communication links and may communicate with a non-3GPP access network using non-3GPP communication links. Even though a specific number of remote units 105, access networks 120, base units 121, wireless communication links 123, and mobile core networks 140 are depicted in FIG. 1, one of skill in the art will recognize that any number of remote units 105, access networks 120, base units 121, communication links 123, and mobile core networks 140 may be included in the wireless communication system 100.

In one implementation, the wireless communication system 100 is compliant with the 5G system specified in the 3GPP specifications. More generally, however, the wireless communication system 100 may implement some other open or proprietary communication network, for example, LTE or WiMAX, among other networks. The present disclosure is not intended to be limited to the implementation of any particular wireless communication system architecture or protocol.

In one embodiment, the remote units 105 may include computing devices, such as desktop computers, laptop computers, personal digital assistants (“PDAs”), tablet computers, smart phones, smart televisions (e.g., televisions connected to the Internet), smart appliances (e.g., appliances connected to the Internet), set-top boxes, game consoles, security systems (including security cameras), vehicle on-board computers, network devices (e.g., routers, switches, modems), or the like. In some embodiments, the remote units 105 include wearable devices, such as smart watches, fitness bands, optical head-mounted displays, or the like. Moreover, the remote units 105 may be referred to as UEs, subscriber units, mobiles, mobile stations, users, terminals, mobile terminals, fixed terminals, subscriber stations, user terminals, wireless transmit/receive unit (“WTRU”), a device, or by other terminology used in the art.

The remote units 105 may communicate directly with one or more of the base units 121 in the 3GPP access network 120 via uplink (“UL”) and downlink (“DL”) communication signals. Furthermore, the UL and DL communication signals may be carried over the 3GPP communication links 123. Here, the access networks 120 is an intermediate network that provide the remote units 105 with access to the mobile core network 140.

In some embodiments, the remote units 105 communicate with a remote host 155 via a network connection with the mobile core network 140. For example, an application in a remote unit 105 (e.g., web browser, media client, telephone/VoIP application) may trigger the remote unit 105 to establish a PDU session (or other data connection) with the mobile core network 140 using the 5G-RAN 115 (e.g., a access network 120). The mobile core network 140 then relays traffic between the remote unit 105 and the data network 150 (e.g., remote host 155) using the PDU session. Note that the remote unit 105 may establish one or more PDU sessions (or other data connections) with the mobile core network 140. As such, the remote unit 105 may have at least one PDU session for communicating with the data network 150. The remote unit 105 may establish additional PDU sessions for communicating with other data network and/or other remote hosts.

The base units 121 may be distributed over a geographic region. In certain embodiments, a base unit 121 may also be referred to as an access terminal, an access point, a base, a base station, a Node-B, an eNB, a gNB, a Home Node-B, a relay node, a device, or by any other terminology used in the art. The base units 121 are generally part of a radio access network (“RAN”), such as the 5G-RAN 115, that may include one or more controllers communicably coupled to one or more corresponding base units 121. These and other elements of radio access network are not illustrated but are well known generally by those having ordinary skill in the art. The base units 121 connect to the mobile core network 140 via the access network 120.

The base units 121 may serve a number of remote units 105 within a serving area, for example, a cell or a cell sector, via a wireless communication link 123. The base units 121 may communicate directly with one or more of the remote units 105 via communication signals. Generally, the base units 121 transmit DL communication signals to serve the remote units 105 in the time, frequency, and/or spatial domain. Furthermore, the DL communication signals may be carried over the wireless communication links 123. The wireless communication links 123 may be any suitable carrier in licensed or unlicensed radio spectrum. The wireless communication links 123 facilitate communication between one or more of the remote units 105 and/or one or more of the base units 121.

In one embodiment, the mobile core network 140 is a 5G core (“5GC”) or the evolved packet core (“EPC”), which may be coupled to a data network (e.g., the data network 150), such as the Internet and private data networks, among other data networks. A remote unit 105 may have a subscription or other account with the mobile core network 140. Each mobile core network 140 belongs to a single public land mobile network (“PLMN”). The present disclosure is not intended to be limited to the implementation of any particular wireless communication system architecture or protocol.

The mobile core network 140 includes several network functions (“NFs”). As depicted, the mobile core network 140 includes multiple user plane functions (“UPFs”). Here, the mobile core network 140 includes at least one UPF 143 that serves the access network 120. The mobile core network 140 also includes multiple control plane functions including, but not limited to, an Access and Mobility Management Function (“AW”) 145 that serves the access network 120, a Session Management Function (“SMF”) 146, a Policy Control Function (“PCF”) 148, and a Unified Data Management function (“UDM”) 149. In certain embodiments, the mobile core network 140 may also include an Authentication Server Function (“AUSF”), a Network Repository Function (“NRF”) (used by the various NFs to discover and communicate with each other over APIs), or other NFs defined for the 5GC.

Although specific numbers and types of network functions are depicted in FIG. 1, one of skill in the art will recognize that any number and type of network functions may be included in the mobile core network 140. Moreover, where the mobile core network 140 is an EPC, the depicted network functions may be replaced with appropriate EPC entities, such as an MME, S-GW, P-GW, HSS, and the like.

In various embodiments, the mobile core network 140 supports different types of mobile data connections and different types of network slices, wherein each mobile data connection utilizes a specific network slice. The different network slices are not shown in FIG. 1 for ease of illustration, but their support is assumed.

To improve user plane security over conventional techniques, in various embodiments, the remote unit 105 may indicate its capability to perform security protection on user plane traffic in the uplink and/or downlink (see messaging 107). In certain embodiments, the remote unit 105 receives an indication (see messaging 109) of a data security policy 111. Here, the data security policy 111 may include instructions for selective application of security protection (e.g., integrity protection) to user plane traffic. Based on the policy 111, the remote unit 105 may apply integrity protection to selected packets, or for selected time duration, or to user plane traffic on an indicated traffic direction (e.g. uplink or downlink). In one solution, the remote unit 105 performs integrity protection for selected packets according to a “packet pattern,” e.g., every 2^{nd} packet or 10^{th} packet of a data flow. Note that the packet pattern may apply to the uplink direction, the downlink direction, or both uplink and downlink directions. Further, the data protection policy may include a first packet pattern for the uplink direction and a second (e.g., different) packet pattern for the downlink direction.

Allowing an asymmetric integrity protection enhances the performance in the remote unit 105 (e.g., UE) by easing the processing and computation requirements associated with integrity protection. In various embodiments, the remote unit 105 performs integrity protection only in one transmission direction, i.e. downlink or uplink. In further embodiments, the data security policy 111 can be enhanced to allow selected packets to be encrypted.

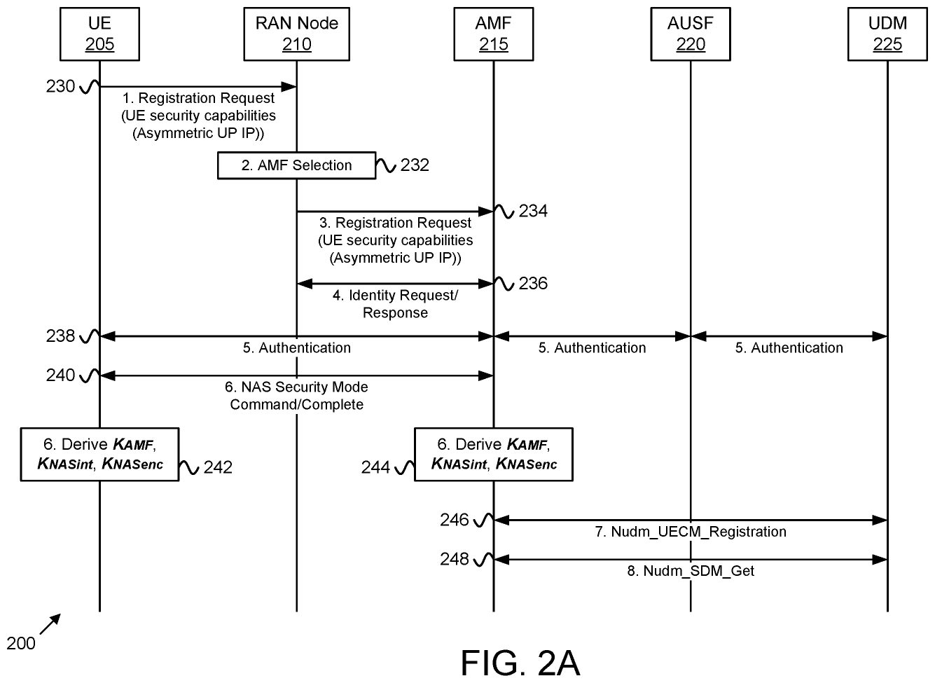

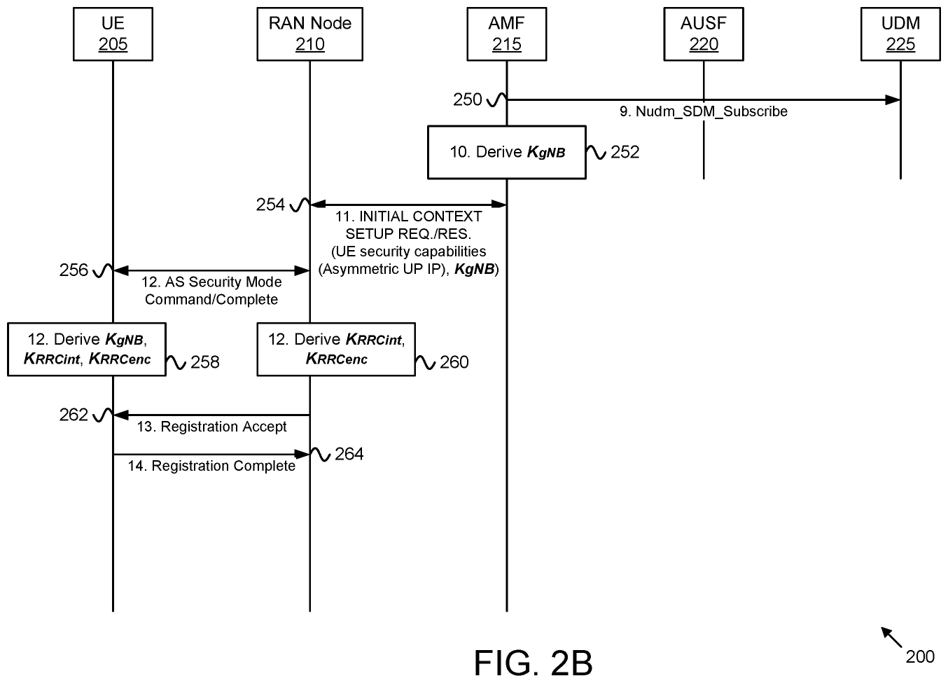

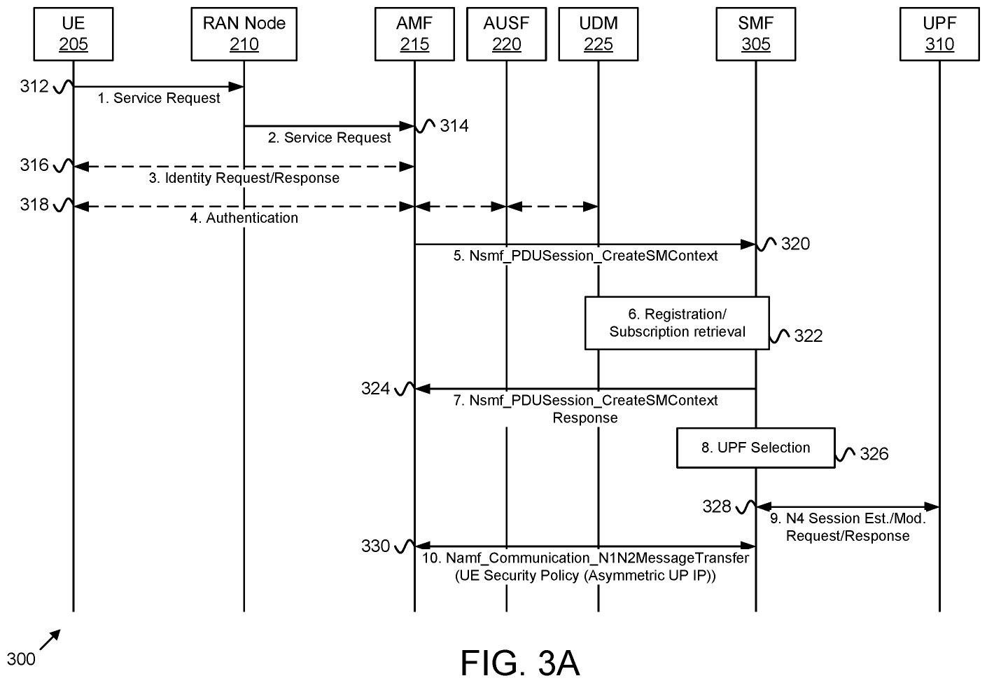

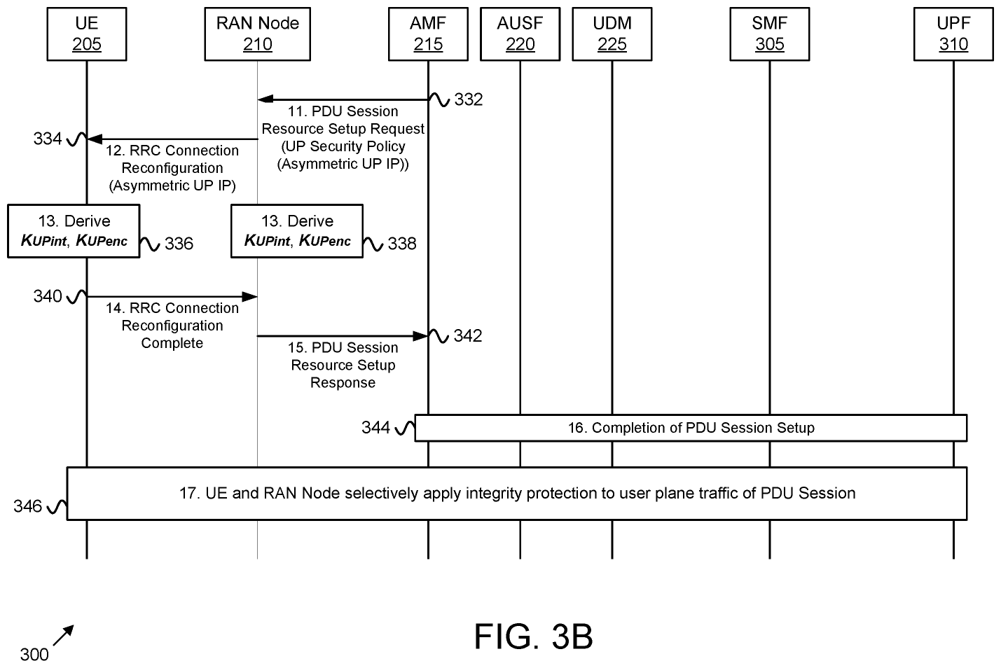

In order to perform the asymmetric and/or selective integrity protection, the remote unit 105 needs to communicate its user plane integrity protection (“UP IP”) capability to the network. The UP IP capability may be a part of a UE security capability sent by the remote unit 105 to the network. In some embodiments, the remote unit 105 communicates its UP IP capability using the Registration procedure, where the Registration Request is enhanced with indication of the remote unit 105's support of Asymmetric UP IP, described below with reference to FIGS. 2A-2B. In some embodiments, the remote unit 105 communicates its UP IP capability using the PDU session establishment procedure, where the PDU session establishment request is enhanced with Asymmetric UP IP policy provisioning and installation in the base unit 121 (e.g., a gNB) as well as in the remote unit 105, described below with reference to FIGS. 3A-3B.

FIGS. 2A-2B depict a procedure 200 for selective security protection of user plane traffic over an access network, according to embodiments of the disclosure. The procedure 200 involves a UE 205 (e.g., an embodiment of the remote unit 105), a RAN node 210 (e.g., an embodiment of a base unit 121), an access and mobility management function (“AMF”) 215, an authentication server function (“AUSF”) 220, and a unified data management (“UDM”) 225, according to embodiments of the disclosure. FIGS. 2A-2B show an enhancement to the normal Registration Request procedure, e.g., as described in 3GPP TS 23.502, which is incorporated by reference herein.

Referring to FIG. 2A, the procedure 200 begins at step 1 with the UE 205 sending a Registration Request message and may indicate in the security capabilities the support of asymmetric UP IP and/or support for selected integrity protection (see messaging 230). In certain embodiments, the UE 205 includes the UE Integrity Protection Maximum Data Rate for symmetric integrity protection mode and for asymmetric for DL only and/or UL only integrity protection mode.

At step 2, the RAN node 210 selects the AMF (e.g., according to 3GPP TS 23.501, see block 232). At step 3, the RAN node 210 sends the Registration Request with the UE security capabilities to the AMF 215 (see messaging 234). At step 4, the AMF 215 may perform an Identity Request to the UE 205 (see messaging 236).

At step 5, the AMF 215 may perform Authentication invoking the AUSF 220 and UDM 225 (see messaging 238). At step 6, the AMF 215 initiates the NAS security with a Security Mode Command resulting in the derivation of the keys for NAS encryption and integrity (see messaging 240). In the depicted embodiment, the UE 205 and AMF 215 each derive keys K_{AMF}, K_{NAsint}, and K_{NASenc} (see blocks 242 and 244). At step 7, the AMF 215 registers with the UDM 225 using Nudm_UECM_Registration and subscribes to be notified when the UDM 225 deregisters this AMF 215 (see messaging 246). At step 8, the AMF 215 retrieves the Access and Mobility Subscription data, SMF Selection Subscription data and UE context in SMF data using Nudm_SDM_Get (see messaging 248).

Continuing at FIG. 2B, at step 9, the AMF 215 subscribes to be notified using Nudm_SDM_Subscribe when the data requested is modified (see messaging 250). At step 10, the AMF 215 derives the key for the RAN node 210 (e.g., key K_{gNB}, see block 252). Note that step 10 may occur with Step 6 or in parallel to any of the following steps. At step 11, the AMF 215 sends a NGAP message (e.g., INITIAL CONTEXT SETUP REQUEST) to the RAN node 210 which includes the UE security capabilities indicating asymmetric UP IP support and/or selected integrity protection (see messaging 254). This message also includes the key derived in step 10. The RAN node 210 replies with a NGAP INITIAL CONTEXT SETUP RESPONSE to the AMF 215 (see messaging 230).

At step 12, the RAN node 210 sends a AS Security Mode Command message to the UE 205 and the UE 205 responds with an AS Security Mode Complete message (see messaging 256). Additionally, the RAN node 210 and the UE 205 derive the keys for RRC encryption and integrity protection (see blocks 258 and 260). At step 13, the AMF 215 sends a Registration Accept message to the UE 205 indicating that the Registration Request has been accepted (see messaging 262). At step 14, the UE 205 may send a Registration Complete message to the AMF 215 (see messaging 264).

FIGS. 3A-3B depict an enhanced PDU Session Establishment procedure 300 for selective security protection of user plane traffic of an access network, according to embodiments of the disclosure. The procedure 300 involves the UE 205, the RAN node 210, the AMF 215, the AUSF 220, the UDM 225, a SMF 305, and a UPF 310. The procedure 300 is an enhancement to the normal PDU session establishment procedure, e.g., as described in 3GPP TS 23.502.

Referring to FIG. 3A, the procedure 300 begins at Step 1 with the UE 205 sending NAS N1 SM container (PDU session establishment request message) encapsulated in either in a N1 MM transport or a Service Request message towards the AMF 215 (see messaging 312). Here, the NAS N1 MM message/Service Request message may be encapsulated in an RRC message to the RAN node 210.

The SM PDU session establishment request message may include a UE security capability, such as the “5GSM Core Network Capability” information element. In various embodiments, the UE Security Capability may include a UE Integrity Protection Maximum Data Rate. In some embodiments, the UE 205 includes the UE Integrity Protection Maximum Data Rate for various integrity protection schemes supported by the UE 205. For example, the UE 205 may include the UE Integrity Protection Maximum Data Rate for symmetric integrity protection and for asymmetric integrity protection for DL only and/or UL only integrity protection mode and/or the UE support of integrity protection of packet pattern. As used herein, “packet pattern” may indicate that integrity protection is applied to every 2^{nd} packet or every 10^{th} packet (and not applied to the other packets).

At step 2, the RAN node 210 sends the N1 MM message to the AMF 215 via N2 transport protocol (see messaging 314). At step 3, the AMF 215 may perform an Identity Request to the UE 205, wherein the UE 205 sends an Identity Response (see messaging 316). At step 4, the AMF 215 may perform Authentication invoking the AUSF 220 and UDM 225 (see messaging 318).

At step 5, the AMF 215 sends a Nsmf_PDUSession_CreateSMContext Request or Nsmf_PDUSession_UpdateSMContext Request to the SMF 305 (see messaging 320). At step 6, if Session Management Subscription data is not available in the SMF 305, then the SMF 305 retrieves the Session Management Subscription data from the UDM 225 and subscribes to be notified when this subscription data is modified (see messaging 322).

At step 7, the SMF 305 creates an SM context and responds to the AMF 215 by providing an SM Context Identifier (see messaging 324). In case the UP Security Policy for the PDU Session is determined to have Integrity Protection set to “Required”, the SMF 305 may, based on local configuration, decide whether to accept or reject the PDU Session request based on the UE Integrity Protection Maximum Data Rate for symmetric and for asymmetric (or selective) integrity protection mode.

In case the UE 205 supports both modes, the SMF 305 may decide based on local policy whether to overwrite symmetric integrity protection with asymmetric integrity protection if the UE 205 cannot fulfill the Maximum Data Rate for symmetric integrity protection but can fulfill the Maximum Data Rate for asymmetric integrity protection. In such embodiments, the SMF 305 considers the UE Integrity Protection Maximum Data Rate for DL only or UL only integrity protection which may differ based on UE computation capabilities. In certain embodiments, the SMF 305 may decide based on local policy whether to overwrite symmetric integrity protection with selected integrity protection according to a specific pattern in order to achieve the target data rate with the UE computation capabilities.

At step 8, the SMF 305 performs UPF selection, for example according to TS 23.502/TS 23.501 (see block 326). At step 9, the SMF 305 sends an N4 Session Establishment/Modification Request to the UPF 310 and provides Packet detection, enforcement, and reporting rules to be installed on the UPF 310 for this PDU Session (see messaging 328). The UPF 310 acknowledges by sending an N4 Session Establishment/Modification Response.

At step 10, the SMF 305 sends the Namf_Communication_N1N2MessageTransfer to the AMF 215 including in the N2 SM container the User Plane Security Enforcement information indicating the integrity protection mode and direction (UL/DL) and the UE Integrity Protection Maximum Data Rate for this mode as well as the policy for selected integrity protection (see messaging 330).

Continuing at FIG. 3B, at step 11, the AMF 215 sends a NGAP PDU SESSION RESOURCE SETUP REQUEST including the UP security policy with the integrity protection mode and the UE Integrity Protection Maximum Data Rate for this mode as well as the security policy for selected integrity protection (said policy also referred to as a “data protection policy,” see messaging 332).

At step 12, the RAN node 210 sends a RRC Connection Reconfiguration Request to the UE for UP security activation containing indications for the activation of UP integrity protection and ciphering for each DRB according to the security policy (see messaging 334). For asymmetric integrity protection mode, the UE 205 also derives the keys for user plane integrity protection but depending on the direction is using NULL scheme (without MAC-I) for the direction without protection or the UP integrity protection key for the direction with protection.

At step 13, the UE 205 and RAN node 210 derive the keys for user plane integrity protection and encryption (see blocks 336 and 338). At step 14, the UE 205 sends the RRC Connection Reconfiguration Complete message to the RAN node 210 (see messaging 340). At step 15, the RAN node 210 sends a PDU SESSION RESOURCE SETUP RESPONSE to the AMF 215 (see messaging 342). At step 16, further steps may be carried out, e.g., according to 3GPP TS 23.502 (see messaging 344).

The PDU Session is now set up and integrity protection (or other data security protection) is to be applied to user plane traffic between UE 205 and RAN node 210. At step 17, the UE 205 and RAN node 210 selectively apply integrity protection to user plane traffic of the established PDU session, e.g., according to the UP data security policy (see block 346). For example, asymmetric integrity protection may be applied to all packets in either DL or UL direction. Alternatively, integrity protection may be applied according to a packet pattern, as described herein.

In order to mitigate the above described man-in-the-middle attack, the security policy may indicate use of integrity protection in the DL direction. This is because if the UE 205 would receive a packet injected by a false base station, the injected packet would not have the expected integrity protection and thus would be discarded by the UE 205 without creating any harm to the end user.

Further, Layer-2 attacks assume that a certain packets size is carrying the DNS request and the attack may be based on fixed value of information elements in the IP header estimate changes. In certain embodiments, this may be mitigated by the UE 205 padding the small packets so that the filtering based on packet size will not work anymore. This mechanism may be optimized to be only used for DNS requests so that those will not be subject to filters anymore but would require the upper layers to indicate the DNS request packet. This approach mitigates the second type of Layer-2 attack, discussed above.

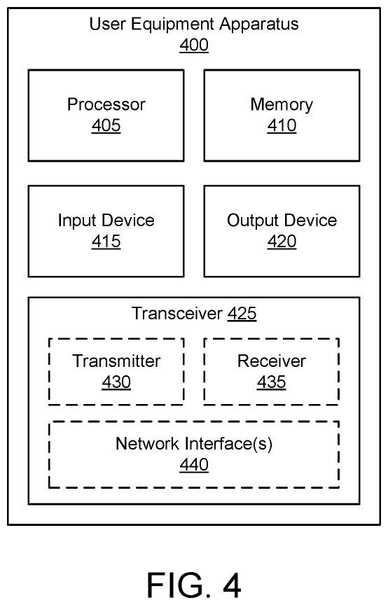

FIG. 4 depicts one embodiment of a user equipment apparatus 400 that may be used for selective security protection of user plane traffic, according to embodiments of the disclosure. The user equipment apparatus 400 may be one embodiment of the remote unit 105. Furthermore, the user equipment apparatus 400 may include a processor 405, a memory 410, an input device 415, an output device 420, a transceiver 425. In some embodiments, the input device 415 and the output device 420 are combined into a single device, such as a touch screen. In certain embodiments, the user equipment apparatus 400 does not include any input device 415 and/or output device 420.

As depicted, the transceiver 425 includes at least one transmitter 430 and at least one receiver 435. Here, the transceiver 425 communicates with a mobile core network (e.g., a 5GC) via an access network, e.g., containing a RAN node. Additionally, the transceiver 425 may support at least one network interface 440. Here, the at least one network interface 440 facilitates communication with an eNB or gNB (e.g., using the “Uu” interface). Additionally, the at least one network interface 440 may include an interface used for communications with an UPF, an SMF, and/or a P-CSCF.

The processor 405, in one embodiment, may include any known controller capable of executing computer-readable instructions and/or capable of performing logical operations. For example, the processor 405 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 405 executes instructions stored in the memory 410 to perform the methods and routines described herein. The processor 405 is communicatively coupled to the memory 410, the input device 415, the output device 420, and the transceiver 425.

In various embodiments, the processor 405 sends (e.g., via the transceiver 425) a UE security capability to a mobile communication network and receives (e.g., via the transceiver 425) an indication of data protection policy. The processor 405 applies a security protection to a select subset of user plane traffic with the mobile communication network according to the data protection policy. In such embodiments, a portion of the user plane traffic is communicated without the security protection.

In some embodiments, sending the UE security capability comprises transmitting the UE security capability in a registration request message. In certain embodiments, the UE security capability indicates a UE Integrity Protection Maximum Data Rate and the data protection policy. In one embodiment, the first apparatus supports multiple integrity protection schemes, wherein the UE Integrity Protection Maximum Data Rate indicates a maximum data rate for each supported integrity protection scheme.

In some embodiments, the data protection policy indicates one of: a sequence number range of packets to which security protection is to be applied, a number of packets to which security protection is to be applied, a time period for which security protection is to be applied, or combinations thereof. In certain embodiments, applying the security protection to the select subset of user plane traffic comprises periodically applying the security protection at an interval indicated by the data protection policy.

In certain embodiments, applying the security protection to the select subset of user plane traffic comprises applying asymmetric integrity protection to user plane traffic in either an uplink direction or a downlink direction. In certain embodiments, applying the security protection to the select subset of user plane traffic comprises applying pattern-based integrity protection to user plane traffic in an uplink direction and/or a downlink direction. In certain embodiments, applying the security protection to the select subset of user plane traffic comprises applying integrity protection to data packets below a threshold size and not to data packets above the threshold size.

The memory 410, in one embodiment, is a computer readable storage medium. In some embodiments, the memory 410 includes volatile computer storage media. For example, the memory 410 may include a RAM, including dynamic RAM (“DRAM”), synchronous dynamic RAM (“SDRAM”), and/or static RAM (“SRAM”). In some embodiments, the memory 410 includes non-volatile computer storage media. For example, the memory 410 may include a hard disk drive, a flash memory, or any other suitable non-volatile computer storage device. In some embodiments, the memory 410 includes both volatile and non-volatile computer storage media. In some embodiments, the memory 410 stores data relating to selective security protection of user plane traffic, for example storing a data protection policy and the like. In certain embodiments, the memory 410 also stores program code and related data, such as an operating system (“OS”) or other controller algorithms operating on the user equipment apparatus 400 and one or more software applications.

The input device 415, in one embodiment, may include any known computer input device including a touch panel, a button, a keyboard, a stylus, a microphone, or the like. In some embodiments, the input device 415 may be integrated with the output device 420, for example, as a touchscreen or similar touch-sensitive display. In some embodiments, the input device 415 includes a touchscreen such that text may be input using a virtual keyboard displayed on the touchscreen and/or by handwriting on the touchscreen. In some embodiments, the input device 415 includes two or more different devices, such as a keyboard and a touch panel.

The output device 420, in one embodiment, may include any known electronically controllable display or display device. The output device 420 may be designed to output visual, audible, and/or haptic signals. In some embodiments, the output device 420 includes an electronic display capable of outputting visual data to a user. For example, the output device 420 may include, but is not limited to, an LCD display, an LED display, an OLED display, a projector, or similar display device capable of outputting images, text, or the like to a user. As another, non-limiting, example, the output device 420 may include a wearable display such as a smart watch, smart glasses, a heads-up display, or the like. Further, the output device 420 may be a component of a smart phone, a personal digital assistant, a television, a table computer, a notebook (laptop) computer, a personal computer, a vehicle dashboard, or the like.

In certain embodiments, the output device 420 includes one or more speakers for producing sound. For example, the output device 420 may produce an audible alert or notification (e.g., a beep or chime). In some embodiments, the output device 420 includes one or more haptic devices for producing vibrations, motion, or other haptic feedback. In some embodiments, all or portions of the output device 420 may be integrated with the input device 415. For example, the input device 415 and output device 420 may form a touchscreen or similar touch-sensitive display. In other embodiments, all or portions of the output device 420 may be located near the input device 415.

As discussed above, the transceiver 425 communicates with one or more network functions of a mobile communication network via one or more access networks. The transceiver 425 operates under the control of the processor 405 to transmit messages, data, and other signals and also to receive messages, data, and other signals. For example, the processor 405 may selectively activate the transceiver 425 (or portions thereof) at particular times in order to send and receive messages.

In various embodiments, the transceiver 425 includes at least one transmitter 430 and at least one receiver 435. One or more transmitters 430 may be used to provide UL communication signals to a base unit 121, such as the AUL transmissions described herein. Similarly, one or more receivers 435 may be used to receive DL communication signals from the base unit 121, as described herein. Although only one transmitter 430 and one receiver 435 are illustrated, the user equipment apparatus 400 may have any suitable number of transmitters 430 and receivers 435. Further, the transmitter(s) 430 and the receiver(s) 435 may be any suitable type of transmitters and receivers. In one embodiment, the transceiver 425 includes a first transmitter/receiver pair used to communicate with a mobile communication network over licensed radio spectrum and a second transmitter/receiver pair used to communicate with a mobile communication network over unlicensed radio spectrum.

In certain embodiments, the first transmitter/receiver pair used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. In some embodiments, the first transmitter/receiver pair and the second transmitter/receiver pair may share one or more hardware components. For example, certain transceivers 425, transmitters 430, and receivers 435 may be implemented as physically separate components that access a shared hardware resource and/or software resource, such as for example, the network interface 440.

In various embodiments, one or more transmitters 430 and/or one or more receivers 435 may be implemented and/or integrated into a single hardware component, such as a multi-transceiver chip, a system-on-a-chip, an application specific integrated circuit (“ASIC”), or other type of hardware component. In certain embodiments, one or more transmitters 430 and/or one or more receivers 435 may be implemented and/or integrated into a multi-chip module. In some embodiments, other components such as the network interface 440 or other hardware components/circuits may be integrated with any number of transmitters 430 and/or receivers 435 into a single chip. In such embodiment, the transmitters 430 and receivers 435 may be logically configured as a transceiver 425 that uses one more common control signals or as modular transmitters 430 and receivers 435 implemented in the same hardware chip or in a multi-chip module.

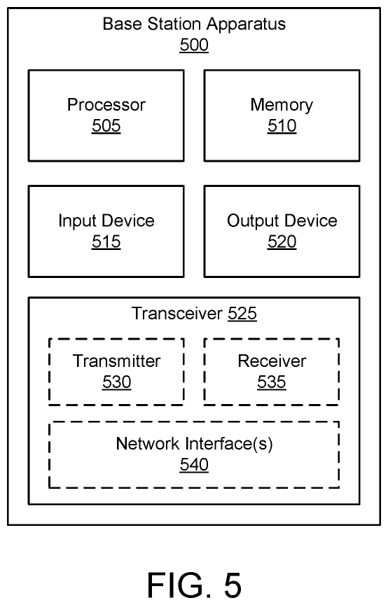

FIG. 5 depicts one embodiment of a base station apparatus 500 that may be used for selective security protection of user plane traffic, according to embodiments of the disclosure. The base station apparatus 500 may be one embodiment of the base unit 121 and/or the RAN node 210. Furthermore, the base station apparatus 500 may include a processor 505, a memory 510, an input device 515, an output device 520, a transceiver 525. In some embodiments, the input device 515 and the output device 520 are combined into a single device, such as a touch screen. In certain embodiments, the base station apparatus 500 does not include any input device 515 and/or output device 520.

As depicted, the transceiver 525 includes at least one transmitter 530 and at least one receiver 535. Here, the transceiver 525 communicates with one or more remote units 105 to provide access to one or more PLMNs. Additionally, the transceiver 525 may support at least one network interface 540. In some embodiments, the transceiver 525 supports a first interface (e.g., an N2 interface) that communicates with control-plane functions (e.g., SMF) in a mobile core network (e.g., a 5GC) and a second interface (e.g., Uu interface) that communicates with a remote unit (e.g., UE) over an access network.

The processor 505, in one embodiment, may include any known controller capable of executing computer-readable instructions and/or capable of performing logical operations. For example, the processor 505 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 505 executes instructions stored in the memory 510 to perform the methods and routines described herein. The processor 505 is communicatively coupled to the memory 510, the input device 515, the output device 520, and the first transceiver 525.

In various embodiments, the processor 505 receives (e.g., via the transceiver 525) a security policy from a network function, the security policy indicating a user plane data protection policy for a remote unit (e.g., UE). The processor 505 sends (e.g., via the transceiver 525) an indication of the data protection policy to the remote unit. The processor 505 applies a security protection to a subset of user plane traffic with the remote unit according to the data protection policy, wherein a portion of the user plane traffic is communicated without the security protection.

In some embodiments, the data protection policy indicates one of: a number of packets to which security protection is to be applied and a time period for which security protection is to be applied. In certain embodiments, applying the security protection to the select subset of user plane traffic comprises periodically applying the security protection at an interval indicated by the data protection policy.

In certain embodiments, applying the security protection to the select subset of user plane traffic comprises applying asymmetric integrity protection to user plane traffic in either an uplink direction or a downlink direction. In certain embodiments, applying the security protection to the select subset of user plane traffic comprises applying pattern-based integrity protection to user plane traffic in an uplink direction and/or a downlink direction. In certain embodiments, applying the security protection to the select subset of user plane traffic comprises applying integrity protection to data packets below a threshold size and not to data packets above the threshold size.

The memory 510, in one embodiment, is a computer readable storage medium. In some embodiments, the memory 510 includes volatile computer storage media. For example, the memory 510 may include a RAM, including dynamic RAM (“DRAM”), synchronous dynamic RAM (“SDRAM”), and/or static RAM (“SRAM”). In some embodiments, the memory 510 includes non-volatile computer storage media. For example, the memory 510 may include a hard disk drive, a flash memory, or any other suitable non-volatile computer storage device. In some embodiments, the memory 510 includes both volatile and non-volatile computer storage media. In some embodiments, the memory 510 stores data relating to selective security protection of user plane traffic, for example storing a data security policy, encryptions keys, and the like. In certain embodiments, the memory 510 also stores program code and related data, such as an operating system (“OS”) or other controller algorithms operating on the base station apparatus 500 and one or more software applications.

The input device 515, in one embodiment, may include any known computer input device including a touch panel, a button, a keyboard, a stylus, a microphone, or the like. In some embodiments, the input device 515 may be integrated with the output device 520, for example, as a touchscreen or similar touch-sensitive display. In some embodiments, the input device 515 includes a touchscreen such that text may be input using a virtual keyboard displayed on the touchscreen and/or by handwriting on the touchscreen. In some embodiments, the input device 515 includes two or more different devices, such as a keyboard and a touch panel.

The output device 520, in one embodiment, may include any known electronically controllable display or display device. The output device 520 may be designed to output visual, audible, and/or haptic signals. In some embodiments, the output device 520 includes an electronic display capable of outputting visual data to a user. For example, the output device 520 may include, but is not limited to, an LCD display, an LED display, an OLED display, a projector, or similar display device capable of outputting images, text, or the like to a user. As another, non-limiting, example, the output device 520 may include a wearable display such as a smart watch, smart glasses, a heads-up display, or the like. Further, the output device 520 may be a component of a smart phone, a personal digital assistant, a television, a table computer, a notebook (laptop) computer, a personal computer, a vehicle dashboard, or the like.

In certain embodiments, the output device 520 includes one or more speakers for producing sound. For example, the output device 520 may produce an audible alert or notification (e.g., a beep or chime). In some embodiments, the output device 520 includes one or more haptic devices for producing vibrations, motion, or other haptic feedback. In some embodiments, all or portions of the output device 520 may be integrated with the input device 515. For example, the input device 515 and output device 520 may form a touchscreen or similar touch-sensitive display. In other embodiments, all or portions of the output device 520 may be located near the input device 515.

As discussed above, the transceiver 525 may communicate with one or more remote units to provide access to one or more PLMNs. The transceiver 525 may also communicate with one or more network functions (e.g., in the mobile core network 140). The transceiver 525 operates under the control of the processor 505 to transmit messages, data, and other signals and also to receive messages, data, and other signals. For example, the processor 505 may selectively activate the transceiver (or portions thereof) at particular times in order to send and receive messages.

In various embodiments, the transceiver 525 includes at least one transmitter 530 and at least one receiver 535. One or more transmitters 530 may be used to provide UL communication signals to a base unit 121, such as the AUL transmissions described herein. Similarly, one or more receivers 535 may be used to receive DL communication signals from the base unit 121, as described herein. Although only one transmitter 530 and one receiver 535 are illustrated, the base station apparatus 500 may have any suitable number of transmitters 530 and receivers 535. Further, the transmitter(s) 530 and the receiver(s) 535 may be any suitable type of transmitters and receivers. In one embodiment, the transceiver 525 includes a first transmitter/receiver pair used to communicate with a mobile communication network over licensed radio spectrum and a second transmitter/receiver pair used to communicate with a mobile communication network over unlicensed radio spectrum.

In certain embodiments, the first transmitter/receiver pair used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. In some embodiments, the first transmitter/receiver pair and the second transmitter/receiver pair may share one or more hardware components. For example, certain transceivers 525, transmitters 530, and receivers 535 may be implemented as physically separate components that access a shared hardware resource and/or software resource, such as for example, the network interface 540.

In various embodiments, one or more transmitters 530 and/or one or more receivers 535 may be implemented and/or integrated into a single hardware component, such as a multi-transceiver chip, a system-on-a-chip, an application specific integrated circuit (“ASIC”), or other type of hardware component. In certain embodiments, one or more transmitters 530 and/or one or more receivers 535 may be implemented and/or integrated into a multi-chip module. In some embodiments, other components such as the network interface 540 or other hardware components/circuits may be integrated with any number of transmitters 530 and/or receivers 535 into a single chip. In such embodiment, the transmitters 530 and receivers 535 may be logically configured as a transceiver 525 that uses one more common control signals or as modular transmitters 530 and receivers 535 implemented in the same hardware chip or in a multi-chip module.

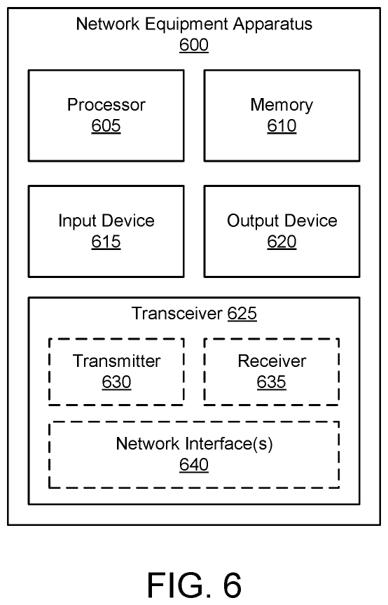

FIG. 6 depicts one embodiment of a network equipment apparatus 600 that may be used for selective security protection of user plane traffic, according to embodiments of the disclosure. The network equipment apparatus 600 may be one embodiment of a network function in a mobile core network, such as a SMF 146 or SMF 305. In another embodiment, the network equipment apparatus may implement the AMF 145 and/or AMF 215. Furthermore, the network equipment apparatus 600 may include a processor 605, a memory 610, an input device 615, an output device 620, a transceiver 625. In some embodiments, the input device 615 and the output device 620 are combined into a single device, such as a touch screen. In certain embodiments, the network equipment apparatus 600 does not include any input device 615 and/or output device 620.

As depicted, the transceiver 625 includes at least one transmitter 630 and at least one receiver 635. Here, the transceiver 625 communicates with one or more RAN nodes and with one or more network functions. Additionally, the transceiver 625 may support at least one network interface 640. In some embodiments, the transceiver 625 supports a first interface (e.g., an N2 interface) that communicates with a RAN node and a second interface that communicates with a remote unit (e.g., UE).

The processor 605, in one embodiment, may include any known controller capable of executing computer-readable instructions and/or capable of performing logical operations. For example, the processor 605 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 605 executes instructions stored in the memory 610 to perform the methods and routines described herein. The processor 605 is communicatively coupled to the memory 610, the input device 615, the output device 620, and the first transceiver 625.

In various embodiments, the processor 605 receives (e.g., via the transceiver 625) a UE security capability for security protection from a UE and via a RAN node. The processor 605 derives a data protection policy based on the UE security capability and sends (e.g., via the transceiver 625) the data protection policy to the RAN node. Here, the RAN node and UE are to apply integrity protection to user plane traffic according to the data protection policy, wherein a portion of the user plane traffic is to be communicated without the security protection.

In some embodiments, the data protection policy indicates an integrity protection mode and a pattern for selectively applying integrity protection to user plane packets. In certain embodiments, the pattern for selectively applying integrity protection to user plane packets indicates an amount of packets to which integrity protection is to be applied and a periodicity for applying integrity protection. In certain embodiments, the UE security capability indicates a UE Integrity Protection Maximum Data Rate, wherein the integrity protection mode and/or the pattern are selected based on the UE Integrity Protection Maximum Data Rate and a target data rate.

In certain embodiments, the data protection policy indicates that asymmetric integrity protection is to be applied to user plane traffic in one of: an uplink direction and a downlink direction. In certain embodiments, the data protection policy indicates that the pattern is to be applied to user plane traffic in an uplink direction and/or a downlink direction. In certain embodiments, applying security protection comprises applying integrity protection to data packets below a threshold size and not to data packets above the threshold size.

The memory 610, in one embodiment, is a computer readable storage medium. In some embodiments, the memory 610 includes volatile computer storage media. For example, the memory 610 may include a RAM, including dynamic RAM (“DRAM”), synchronous dynamic RAM (“SDRAM”), and/or static RAM (“SRAM”). In some embodiments, the memory 610 includes non-volatile computer storage media. For example, the memory 610 may include a hard disk drive, a flash memory, or any other suitable non-volatile computer storage device. In some embodiments, the memory 610 includes both volatile and non-volatile computer storage media. In some embodiments, the memory 610 stores data relating to selective security protection of user plane traffic, for example storing a data protection policy, and the like. In certain embodiments, the memory 610 also stores program code and related data, such as an operating system (“OS”) or other controller algorithms operating on the network equipment apparatus 600 and one or more software applications.

The input device 615, in one embodiment, may include any known computer input device including a touch panel, a button, a keyboard, a stylus, a microphone, or the like. In some embodiments, the input device 615 may be integrated with the output device 620, for example, as a touchscreen or similar touch-sensitive display. In some embodiments, the input device 615 includes a touchscreen such that text may be input using a virtual keyboard displayed on the touchscreen and/or by handwriting on the touchscreen. In some embodiments, the input device 615 includes two or more different devices, such as a keyboard and a touch panel.

The output device 620, in one embodiment, may include any known electronically controllable display or display device. The output device 620 may be designed to output visual, audible, and/or haptic signals. In some embodiments, the output device 620 includes an electronic display capable of outputting visual data to a user. For example, the output device 620 may include, but is not limited to, an LCD display, an LED display, an OLED display, a projector, or similar display device capable of outputting images, text, or the like to a user. As another, non-limiting, example, the output device 620 may include a wearable display such as a smart watch, smart glasses, a heads-up display, or the like. Further, the output device 620 may be a component of a smart phone, a personal digital assistant, a television, a table computer, a notebook (laptop) computer, a personal computer, a vehicle dashboard, or the like.

In certain embodiments, the output device 620 includes one or more speakers for producing sound. For example, the output device 620 may produce an audible alert or notification (e.g., a beep or chime). In some embodiments, the output device 620 includes one or more haptic devices for producing vibrations, motion, or other haptic feedback. In some embodiments, all or portions of the output device 620 may be integrated with the input device 615. For example, the input device 615 and output device 620 may form a touchscreen or similar touch-sensitive display. In other embodiments, all or portions of the output device 620 may be located near the input device 615.

As discussed above, the transceiver 625 may communicate with one or more RAN Nodes and/or with one or more network functions. The transceiver 625 may also communicate with one or more remote units via the RAN. The transceiver 625 operates under the control of the processor 605 to transmit messages, data, and other signals and also to receive messages, data, and other signals. For example, the processor 605 may selectively activate the transceiver (or portions thereof) at particular times in order to send and receive messages.

The transceiver 625 may include one or more transmitters 630 and one or more receivers 635. In certain embodiments, the one or more transmitters 630 and/or the one or more receivers 635 may share transceiver hardware and/or circuitry. For example, the one or more transmitters 630 and/or the one or more receivers 635 may share antenna(s), antenna tuner(s), amplifier(s), filter(s), oscillator(s), mixer(s), modulator/demodulator(s), power supply, and the like. In one embodiment, the transceiver 625 implements multiple logical transceivers using different communication protocols or protocol stacks, while using common physical hardware.

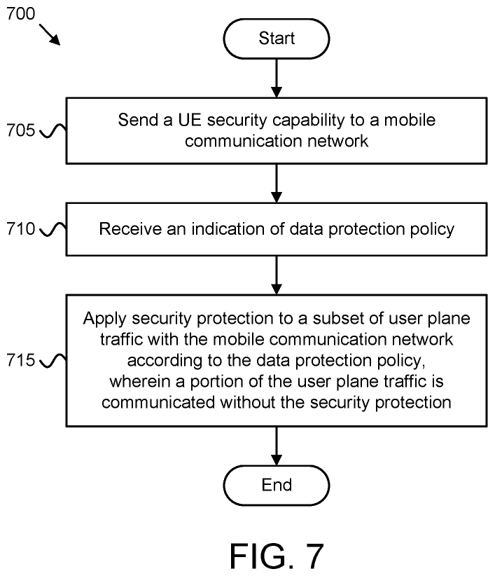

FIG. 7 depicts a method 700 for selective security protection of user plane traffic, according to embodiments of the disclosure. In some embodiments, the method 700 is performed by an apparatus, such as the remote unit 105, the UE 205, and/or the user equipment apparatus 400. In certain embodiments, the method 700 may be performed by a processor executing program code, for example, a microcontroller, a microprocessor, a CPU, a GPU, an auxiliary processing unit, a FPGA, or the like.

The method 700 begins and sends 705 a UE security capability to a mobile communication network. The method 700 includes receiving 710 an indication of data protection policy. The method 700 includes applying 715 a security protection to a subset of user plane traffic with the mobile communication network according to the data protection policy, wherein a portion of the user plane traffic is communicated without the security protection. The method 700 ends.

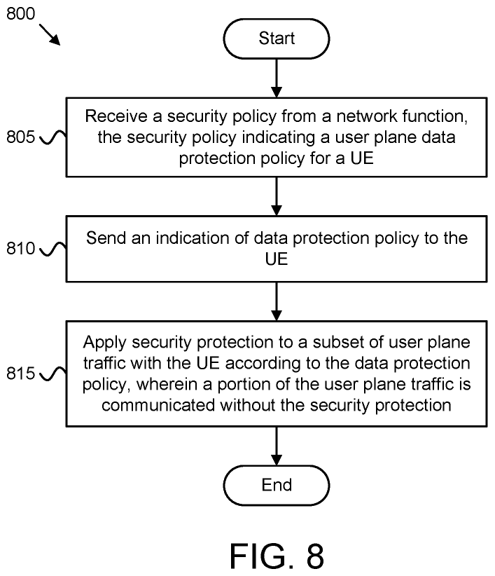

FIG. 8 depicts a method 800 for selective security protection of user plane traffic, according to embodiments of the disclosure. In some embodiments, the method 800 is performed by an apparatus, such as the base unit 121, the RAN node 210, and/or the base station apparatus 500. In certain embodiments, the method 800 may be performed by a processor executing program code, for example, a microcontroller, a microprocessor, a CPU, a GPU, an auxiliary processing unit, a FPGA, or the like.

The method 800 begins and receives 805 a security policy from a network function. Here, the security policy indicates a user plane data protection policy for a UE (e.g., remote unit 105 and/or UE 205). The method 800 includes sending 810 an indication of the data protection policy to the UE. The method 800 includes applying 815 security protection to a subset user plane traffic with the UE according to the data protection policy, wherein a portion of the user plane traffic is communicated without the security protection. The method 800 ends.

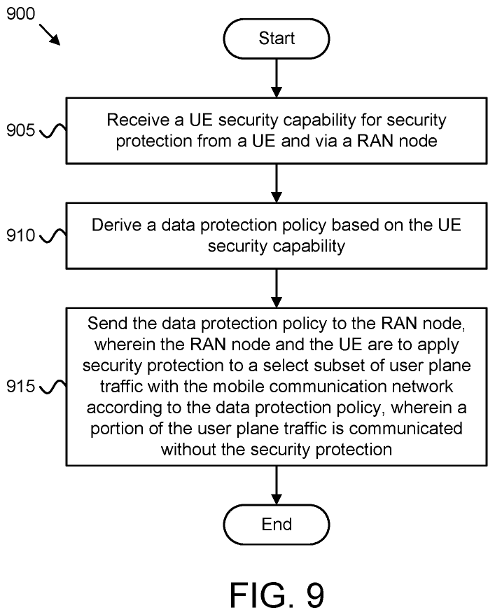

FIG. 9 depicts a method 900 for selective security protection of user plane traffic, according to embodiments of the disclosure. In some embodiments, the method 900 is performed by a network function, such as the SMF 146, the SMF 305, and/or the network equipment apparatus 600. In certain embodiments, the method 900 may be performed by a processor executing program code, for example, a microcontroller, a microprocessor, a CPU, a GPU, an auxiliary processing unit, a FPGA, or the like.

The method 900 begins and receives 905 a UE security capability for security protection from a UE and via a RAN node. The method 900 includes deriving 910 a data protection policy based on the UE security capability. The method 900 includes sending 915 the data protection policy to the RAN node, wherein the RAN node and UE are to apply integrity protection to user plane traffic according to the data protection policy, wherein a portion of the user plane traffic is to be communicated without the security protection. The method 900 ends.

Disclosed herein is a first apparatus for selective security protection of user plane traffic, according to embodiments of the disclosure. The first apparatus may be implemented by a UE, such as a remote unit 105, a UE 205, and/or user equipment apparatus 400. The first apparatus includes a processor and a transceiver that sends a UE security capability to a mobile communication network and receives an indication of data protection policy. The processor applies a security protection to a subset of user plane traffic with the mobile communication network according to the data protection policy. In such embodiments, a portion of the user plane traffic is communicated without the security protection.

In some embodiments, sending the UE security capability comprises transmitting the UE security capability in a registration request message. In certain embodiments, the UE security capability indicates a UE Integrity Protection Maximum Data Rate and the data protection policy. In one embodiment, the first apparatus supports multiple integrity protection schemes, wherein the UE Integrity Protection Maximum Data Rate indicates a maximum data rate for each supported integrity protection scheme.

In some embodiments, the data protection policy indicates one of: a sequence number range of packets to which security protection is to be applied, a number of packets to which security protection is to be applied, a time period for which security protection is to be applied, or combinations thereof. In certain embodiments, applying the security protection to the subset of user plane traffic comprises periodically applying the security protection at an interval indicated by the data protection policy.

In certain embodiments, applying the security protection to the subset of user plane traffic comprises applying asymmetric integrity protection to user plane traffic in either an uplink direction or a downlink direction. In certain embodiments, applying the security protection to the subset of user plane traffic comprises applying pattern-based integrity protection to user plane traffic in an uplink direction and/or a downlink direction. In certain embodiments, applying the security protection to the subset of user plane traffic comprises applying integrity protection to data packets below a threshold size and not to data packets above the threshold size.

Disclosed herein is a first method for selective security protection of user plane traffic, according to embodiments of the disclosure. The first method may be implemented by a UE, such as a remote unit 105, the UE 205 and/or the user equipment apparatus 400. The first method includes sending a UE security capability to a mobile communication network and receiving an indication of data protection policy. The first method includes applying a security protection to a subset of user plane traffic with the mobile communication network according to the data protection policy, wherein a portion of the user plane traffic is communicated without the security protection.

In some embodiments, sending the UE security capability includes transmitting the UE security capability in a registration request message. In certain embodiments, the UE security capability indicates a UE Integrity Protection Maximum Data Rate and the data protection policy. In some embodiments, the data protection policy indicates one of: a sequence number range of packets to which security protection is to be applied, a number of packets to which security protection is to be applied and a time period for which security protection is to be applied. In certain embodiments, applying the security protection to the subset of user plane traffic comprises periodically applying the security protection at an interval indicated by the data protection policy.

In certain embodiments, applying the security protection to the subset of user plane traffic comprises applying asymmetric integrity protection to user plane traffic in either an uplink direction or a downlink direction. In certain embodiments, applying the security protection to the subset of user plane traffic comprises applying pattern-based integrity protection to user plane traffic in an uplink direction and/or a downlink direction. In certain embodiments, applying the security protection to the subset of user plane traffic comprises applying integrity protection to data packets below a threshold size and not to data packets above the threshold size.

Disclosed herein is a second apparatus for selective security protection of user plane traffic, according to embodiments of the disclosure. The second apparatus may be implemented by a RAN node, such as a base unit 121, the RAN node 210, and/or base station apparatus 500. The second apparatus includes a processor and a transceiver that receives a security policy from a network function, the security policy indicating a user plane data protection policy for a remote unit. The processor controls the transceiver to send an indication of the data protection policy to the remote unit. The processor applies a security protection to a subset of user plane traffic with the remote unit according to the data protection policy, wherein a portion of the user plane traffic is communicated without the security protection.

In some embodiments, the data protection policy indicates one of: a number of packets to which security protection is to be applied and a time period for which security protection is to be applied. In certain embodiments, applying the security protection to the subset of user plane traffic comprises periodically applying the security protection at an interval indicated by the data protection policy.

In certain embodiments, applying the security protection to the subset of user plane traffic comprises applying asymmetric integrity protection to user plane traffic in either an uplink direction or a downlink direction. In certain embodiments, applying the security protection to the subset of user plane traffic comprises applying pattern-based integrity protection to user plane traffic in an uplink direction and/or a downlink direction. In certain embodiments, applying the security protection to the subset of user plane traffic comprises applying integrity protection to data packets below a threshold size and not to data packets above the threshold size.

Disclosed herein is a second method for selective security protection of user plane traffic, according to embodiments of the disclosure. The second method may be implemented by a RAN node, such as a base unit 121, RAN node 210, and/or base station apparatus 500. The second method includes receiving a security policy from a network function, the security policy indicating a user plane data protection policy for a UE and sending an indication of the data protection policy to the UE. The second method includes applying security protection to a subset user plane traffic with the UE according to the data protection policy, wherein a portion of the user plane traffic is communicated without the security protection.

In some embodiments, the data protection policy indicates one of: a number of packets to which security protection is to be applied and a time period for which security protection is to be applied. In certain embodiments, applying the security protection to the subset of user plane traffic comprises periodically applying the security protection at an interval indicated by the data protection policy.

In certain embodiments, applying security protection to a subset user plane traffic comprises applying asymmetric integrity protection to user plane traffic in either an uplink direction or a downlink direction. In certain embodiments, applying security protection to a subset user plane traffic comprises applying pattern-based integrity protection to user plane traffic in an uplink direction and/or a downlink direction. In certain embodiments, applying integrity protection comprises applying integrity protection to data packets below a threshold size and not to data packets above the threshold size.

Disclosed herein is a third apparatus for selective security protection of user plane traffic, according to embodiments of the disclosure. The third apparatus may be implemented by a network function, such as a SMF 146, SMF 305, and/or network equipment apparatus 600. The third apparatus includes a processor and a transceiver that receives a UE security capability for security protection from a UE and via a RAN node. The processor derives a data protection policy based on the UE security capability and sends the data protection policy to the RAN node. Here, the RAN node and UE are to apply integrity protection to user plane traffic according to the data protection policy, wherein a portion of the user plane traffic is to be communicated without the security protection.

In some embodiments, the data protection policy indicates an integrity protection mode and a pattern for selectively applying integrity protection to user plane packets. In certain embodiments, the pattern for selectively applying integrity protection to user plane packets indicates an amount of packets to which integrity protection is to be applied and a periodicity for applying integrity protection. In certain embodiments, the UE security capability indicates a UE Integrity Protection Maximum Data Rate, wherein the integrity protection mode and/or the pattern are selected based on the UE Integrity Protection Maximum Data Rate and a target data rate.

In certain embodiments, the data protection policy indicates that asymmetric integrity protection is to be applied to user plane traffic in one of: an uplink direction and a downlink direction. In certain embodiments, the data protection policy indicates that the pattern is to be applied to user plane traffic in an uplink direction and/or a downlink direction. In certain embodiments, applying security protection comprises applying integrity protection to data packets below a threshold size and not to data packets above the threshold size.

Disclosed herein is a third method for selective security protection of user plane traffic, according to embodiments of the disclosure. The third method may be implemented by a network function, such as a SMF 146, SMF 305, and/or network equipment apparatus 600. The third method includes receiving a UE security capability for security protection from a UE and via a RAN node and deriving a data protection policy based on the UE security capability. The third method includes sending the data protection policy to the RAN node, wherein the RAN node and UE are to apply integrity protection to user plane traffic according to the data protection policy, wherein a portion of the user plane traffic is to be communicated without the security protection.

In some embodiments, the data protection policy indicates an integrity protection mode and a pattern for selectively applying integrity protection to user plane packets. In certain embodiments, the pattern for selectively applying integrity protection to user plane packets indicates an amount of packets to which integrity protection is to be applied and a periodicity for applying integrity protection. In certain embodiments, the UE security capability indicates a UE Integrity Protection Maximum Data Rate, wherein the integrity protection mode and/or the pattern are selected based on the UE Integrity Protection Maximum Data Rate and a target data rate.

In certain embodiments, the data protection policy indicates that asymmetric integrity protection is to be applied to user plane traffic in one of: an uplink direction and a downlink direction. In certain embodiments, the data protection policy indicates that the pattern is to be applied to user plane traffic in an uplink direction and/or a downlink direction. In certain embodiments, applying security protection comprises applying integrity protection to data packets below a threshold size and not to data packets above the threshold size.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. An apparatus comprising:
a transceiver that:
sends a UE security capability to a mobile communication network; and
receives an indication of data protection policy; and
a processor that applies a security protection to a subset of user plane traffic with the mobile communication network according to the data protection policy,
wherein a portion of the user plane traffic is communicated without the security protection.

2. The apparatus of claim 1, wherein sending the UE security capability comprises transmitting the UE security capability in a registration request message.

3. The apparatus of claim 1, wherein the UE security capability indicates a UE Integrity Protection Maximum Data Rate for a data protection policy.

4. The apparatus of claim 1, wherein the data protection policy indicates one of: a sequence number range of packets to which security protection is to be applied, a number of packets to which security protection is to be applied and a time period for which security protection is to be applied.

5. The apparatus of claim 4, wherein applying the security protection to the subset of user plane traffic comprises periodically applying the security protection at an interval indicated by the data protection policy.

6. The apparatus of claim 1, wherein applying the security protection to the subset of user plane traffic comprises applying asymmetric integrity protection to user plane traffic in either an uplink direction or a downlink direction.

7. The apparatus of claim 1, wherein applying the security protection to the subset of user plane traffic comprises applying pattern-based integrity protection to user plane traffic in an uplink direction and/or a downlink direction.

8. The apparatus of claim 1, wherein applying the security protection to the subset of user plane traffic comprises applying integrity protection to data packets below a threshold size and not to data packets above the threshold size.

9. A method performed by a UE, the method comprising:
sending a UE security capability to a mobile communication network;
receiving an indication of data protection policy; and
applying a security protection to a subset of user plane traffic with the mobile communication network according to the data protection policy,
wherein a portion of the user plane traffic is communicated without the security protection.

10. The method of claim 9, wherein the data protection policy indicates an integrity protection mode and a pattern for selectively applying integrity protection to user plane packets.

11. The method of claim 10, wherein the pattern for selectively applying integrity protection to user plane packets indicates an amount of packets to which integrity protection is to be applied and a periodicity for applying integrity protection.

12. The method of claim 10, wherein the UE security capability indicates a UE Integrity Protection Maximum Data Rate, wherein the integrity protection mode and/or the pattern are selected based on the UE Integrity Protection Maximum Data Rate and a target data rate.

13. An apparatus comprising:
a transceiver that:
receives a security policy from a network function, the security policy indicating a user plane data protection policy for a remote unit; and
sends an indication of the data protection policy to the remote unit; and
a processor that applies a security protection to a subset of user plane traffic with the remote unit according to the data protection policy,
wherein a portion of the user plane traffic is communicated without the security protection.

14. The apparatus of claim 13, wherein the data protection policy indicates one of: a number of packets to which security protection is to be applied and a time period for which security protection is to be applied.

15. The apparatus of claim 14, wherein applying the security protection to the subset of user plane traffic comprises periodically applying the security protection at an interval indicated by the data protection policy.

16. The apparatus of claim 13, wherein applying the security protection to the subset of user plane traffic comprises applying asymmetric integrity protection to user plane traffic in either an uplink direction or a downlink direction.

17. The apparatus of claim 13, wherein applying the security protection to the subset of user plane traffic comprises applying pattern-based integrity protection to user plane traffic in an uplink direction and/or a downlink direction.

18. The apparatus of claim 13, wherein applying the security protection to the subset of user plane traffic comprises applying integrity protection to data packets below a threshold size and not to data packets above the threshold size.

19. A method performed by a RAN node, the method comprising:
receiving a security policy from a network function, the security policy indicating a user plane data protection policy for a UE;
sending an indication of the data protection policy to the UE; and
applying security protection to a subset user plane traffic with the UE according to the data protection policy,
wherein a portion of the user plane traffic is communicated without the security protection.

20. The method of claim 19, wherein applying the security protection to the subset of user plane traffic comprises applying pattern-based integrity protection to user plane traffic in an uplink direction and/or a downlink direction.
